(19) United States
(12) Patent Application Publication
(10) Pub. No.: US 2020/0335791 A1
(43) Pub. Date: Oct. 22, 2020

(54) BINDER FOR SECONDARY BATTERY ELECTRODE, AND USE THEREOF

(71) Applicant: TOAGOSEI CO. LTD., Tokyo (JP)

(72) Inventors: Naohiko SAITO, Nagoya-shi (JP); Tomoko NAKANO, Nagoya-shi (JP); Atsushi NISHIWAKI, Nagoya-shi (JP); Takashi HASEGAWA, Nagoya-shi (JP); Hideo MATSUZAKI, Nagoya-shi (JP)

(73) Assignee: TOAGOSEI CO. LTD., Tokyo (JP)

(21) Appl. No.: 16/759,044

(22) PCT Filed: Oct. 23, 2018
(86) PCT No.: PCT/JP2018/039262

§ 371 Date: Apr. 24, 2020

(30) Foreign Application Priority Data
Oct. 24, 2017 (JP) 2017-204881

(51) Int. Cl. H01M 4/62; H01M 4/36; H01M 4/66; H01M 10/0525

(52) U.S. Cl. CPC H01M 4/622; H01M 4/364; H01M 2004/021; H01M 10/0525; H01M 4/663

(57) ABSTRACT

An aqueous binder for secondary batteries, which has a binding capacity superior than conventional binders while having fine coating property; a secondary battery electrode mixture layer composition and a secondary battery electrode which are acquired by using the binder. This binder for secondary battery electrodes contains: a crosslinked polymer or a salt thereof having a water-swelling degree of 5.0-100 at pH8.

### TECHNICAL FIELD

The present teaching relates to a binder for a secondary battery electrode, and to a use thereof.

### BACKGROUND ART

Power storage devices such as nickel-hydride secondary batteries, lithium ion secondary batteries, electric double-layer capacitors and the like are in practical use as secondary batteries. To prepare the electrodes used in these secondary batteries, a composition containing an active material, a binder and the like for forming an electrode mixture layer is coated, dried and the like on a collector. In the case of lithium ion secondary batteries for example, aqueous binders containing styrene-butadiene rubber (SBR) latex and carboxymethyl cellulose (CMC) are being used as binders in negative electrode mixture layer compositions. Binders containing aqueous solutions or aqueous dispersions of acrylic polymers are also known as binders with excellent dispersibility and binding ability. On the other hand, N-methyl-2-pyrrolidone (NMP) solutions of polyvinylidene fluoride (PVDF) are widely used as binders in positive electrode mixture layers.

As the uses of various secondary batteries continue to expand, meanwhile, demands for increased energy density, reliability and durability are tending to increase. For example, specifications using silicon active materials as negative electrode active materials are in increased use as a means of increasing the capacitance of lithium ion secondary batteries. However, silicon active materials are known to undergo large volume changes during charging and discharging, causing peeling, detachment and the like of the electrode mixture layer during repeated use, and resulting in problems such as reduced battery capacitance and deterioration of the cycle characteristics (durability). In general, an effective way of controlling these problems is to increase the binding ability of the binder, and research is being done into increasing the binding ability of the binder with the aim of improving durability.

For example, Patent Literature 1 discloses an acrylic polymer crosslinked with a polyalkenyl ether as a binding agent for forming a negative electrode coating of a lithium ion secondary battery. The aqueous electrode binder for a secondary battery disclosed in Patent Literature 2 contains a structural unit derived from an ethylenically unsaturated carboxylic acid salt monomer and a structural unit derived from an ethylenically unsaturated carboxylic acid ester monomer and has a specific aqueous solution viscosity. Patent Literature 3 discloses an aqueous dispersion with a specific viscosity containing a salt of a crosslinked polymer having a structural unit derived from an ethylenically unsaturated carboxylic acid salt monomer.

### CITATION LIST

### Patent Literature

[Patent Literature 1] JP2000-294247A
[Patent Literature 2] JP2015-18776A
[Patent Literature 3] WO2016/158939

### SUMMARY

### Technical Problem

The binders disclosed in Patent Literature 1 to 3 can all confer good binding ability, but as the performance of secondary batteries improves, there is increased demand for binders with even greater binding force.

In general, increasing to molecular weight of the polymer in the binder is effective for increasing binding ability. However, if the binder is made of a non-crosslinked polymer for example, the viscosity of an electrode mixture layer slurry containing this binder increases as the molecular weight increases, potentially leading to poor coating performance. Although the viscosity of the slurry can be decreased by lowering the concentration of the active material, binder and the like in the slurry, this is undesirable from the standpoint of productivity.

With a crosslinked polymer that forms a microgel in the medium, on the other hand, the viscosity is not greatly affected even if the molecular weight (primary chain length) is increased. However, the inventors' researches have shown that simply increasing the primary chain length of the crosslinked polymer has only a limited improvement effect of binding ability.

The aqueous binder for a secondary battery electrode provided by these disclosures was developed in light of these circumstances and has good coating properties as well as better binding ability than before. The disclosures also provide a secondary battery electrode mixture layer composition and a secondary battery electrode obtained using this binder.

### Solution to Technical Problem

The inventors discovered as a result of earnest research aimed at solving these problems that both the coating properties and the binding ability of the electrode mixture layer slurry are excellent when using a binder containing a crosslinked polymer or salt thereof the swelling degree of which in an aqueous medium (hereunder called the “water swelling degree”) has been adjusted appropriately. The present disclosure provides the following solutions based on these findings.

The present teaching is as follows.
(1) A binder for a secondary battery electrode, the binder containing a crosslinked polymer or salt thereof,

wherein the crosslinked polymer or salt thereof has a water swelling degree at pH 8 of 5.0 or more and 10.0 or less.
(2) The binder for a secondary battery electrode according to (1) above, wherein the crosslinked polymer or salt thereof has a water swelling degree at pH 4 of at least 2.0.
(3) The binder for a secondary battery electrode according to (1) or (2) above, wherein the crosslinked polymer has a structural unit derived from an ethylenically unsaturated carboxylic acid monomer in an amount of 50 mass % or more and 100 mass % or less of the total structural units of the crosslinked polymer.
(4) The binder for a secondary battery electrode according to any of (1) to (3) above, wherein the crosslinked polymer has been crosslinked with a crosslinkable monomer.
(5) The binder for a secondary battery electrode according to any of (1) to (4) above, wherein the crosslinked polymer, after being neutralized to a degree of neutralization of 80% or more and 100 mol % or less, has a particle diameter measured in an aqueous medium of 0.1 μm or more and 10 μm or less as a volume-based median diameter.
(6) The binder for a secondary battery electrode according to any of (1) to (5) above, wherein the crosslinked polymer, after being neutralized to a degree of neutralization of 80 mol % or more and 100 mol % or less, has a particle size distribution of 1.5 or less, the particle size distribution obtained by dividing the volume average particle size measured in an aqueous medium by the number average particle size,
(7) A secondary battery electrode mixture layer composition, comprising: the binder according to any of (1) to (6) above; an active material; and water.
(8) The secondary battery electrode mixture layer composition according to (7) above, comprising a carbon material or a silicon material as a negative electrode active material.
(9) A secondary battery electrode comprising, a mixture layer formed from the secondary battery electrode mixture layer composition according to (7) or (8) above on a surface of a collector.

### Advantageous Effects

The binder for a secondary battery electrode of the present teaching exhibits excellent binding ability with respect to an electrode active material and the like. This binder can also provide good adhesiveness with a collector. Consequently, an electrode mixture layer containing this binder and an electrode provided therewith can maintain integrity while having excellent binding ability. It is thus possible to suppress deterioration of the electrode mixture layer due to volume changes and shape changes in the active material caused by charging and discharging and obtain a secondary battery with high durability (cycle characteristics). Moreover, a mixture layer slurry containing the binder for a secondary battery electrode of the present teaching also has good coating properties.

### BRIEF DESCRIPTION OF DRAWINGS

FIG. 1 shows an apparatus used to measure water swelling degree of a crosslinked polymer or salt thereof.

### DESCRIPTION OF EMBODIMENTS

Because the secondary battery electrode mixture layer composition of the present teaching has good binding ability with an electrode material and good adhesiveness on a collector, it can form an electrode mixture layer with good integrity and yield a secondary battery electrode with good electrode characteristics.

The binder for a secondary battery electrode of the present teaching contains a crosslinked polymer or salt thereof, and can be mixed with an active material and water to obtain an electrode mixture layer composition. This composition may be a slurry that can be coated on the collector, or it may be prepared as a wet powder and pressed onto the collector surface. The secondary battery electrode of the present teaching is obtained by forming a mixture layer from this composition on the surface of a copper foil, aluminum foil or other collector.

Hereinafter, the binder for a secondary battery electrode, the composition for a secondary battery electrode mixture layer, and the secondary battery electrode obtained using the binder will be described in detail. In the present specification, “(meth) acryl” means acryl and/or methacryl, and “(meth) acrylate” means acrylate and/or methacrylate. Further, “(meth) acryloyl group” means an acryloyl group and/or a methacryloyl group.

(Binder)

The binder of the teaching contains a crosslinked polymer or salt thereof. This crosslinked polymer may have a structural unit derived from an ethylenically unsaturated carboxylic acid.

(Structural Units of Crosslinked Polymer)

### (Structural Unit Derived From Ethylenically Unsaturated Carboxylic Acid Monomer)

The crosslinked polymer may have a structural unit (hereunder also called “component (a)”) derived from an ethylenically unsaturated carboxylic acid monomer. If the crosslinked polymer has carboxyl groups due to having this structural unit, an electrode with low resistance and excellent high-rate characteristics can be obtained because adhesiveness with the collector is improved, and also because the lithium ion desolvation effects and ion conductivity are excellent. This also confers water swellability, which can increase the dispersion stability of the active material and the like in the mixture layer composition.

The component (a) can be introduced into the crosslinked polymer by, for example, polymerizing monomers including an ethylenically unsaturated carboxylic acid monomer. It can also be obtained by first (co)polymerizing and then hydrolyzing a (meth)acrylic acid ester monomer. Alternatively, (meth)acrylamide, (meth)acrylonitrile and the like may be first polymerized and then treated with a strong alkali, or a polymer having a hydroxyl group may be reacted with an acid anhydride.

Examples of ethylenically unsaturated carboxylic acid monomers include (meth)acrylic acid, itaconic acid, crotonic acid, maleic acid, fumaric acid; (meth)acrylamide alkyl carboxylic acids such as (meth)acrylamidohexanoic acid and (meth)acrylamidododecanoic acid; ethylenically unsaturated monomers having carboxyl groups, such as succinic acid monohydroxyethyl (meth)acrylate, ω-carboxy-caprolactone mono(meth)acrylate and ß-carboxyethyl (meth)acrylate, and (partial) alkali neutralization products of these, and one of these may be used alone, or a combination of two or more may be used. Of these, a compound having an acryloyl group as a polymerizable functional group is preferred because the polymerization rate is faster, resulting in a polymer with a long primary chain length and a binder with good binding ability, and acrylic acid is especially desirable. A polymer with a high carboxyl group content can be obtained by using acrylic acid as the ethylenically unsaturated carboxylic acid monomer.

The content of the component (a) in the crosslinked polymer is not particularly limited but may be for example from 10 mass % to 100 mass % of the total structural units of the crosslinked polymer. If the content of the component (a) is within this range, excellent adhesiveness on the collector can be easily ensured. The lower limit is for example not less than 20 mass %, or for example not less than 30 mass %, or for example not less than 40 mass %. The lower limit may also be not less than 50 mass %, or for example not less than 60 mass %, or for example not less than 70 mass %, or for example not less than 80 mass %. The upper limit is for example not more than 99 mass %, or for example not more than 98 mass %, or for example not more than 95 mass %, or for example not more than 90 mass %. The range of content may be a suitable combination of these lower and upper limits, such as for example from 10 mass % to 100 mass %, or for example from 20 mass % to 100 mass %, or for example from 30 mass % to 100 mass %, or for example from 50 mass % to 100 mass %, or for example from 50 mass % to 99 mass %. If the ratio of the component (a) relative to the total structural units is less than 10 mass %, the dispersion stability and binding ability and the durability of the resulting battery may be inadequate.

(Other Structural Units)

The crosslinked polymer of the present teaching may contain, in addition to the component (a), a structural unit (hereunder referred to as “component (b)”) derived from another ethylenically unsaturated monomer that is copolymerizable with the component (a). Examples of the component (b) include structural units derived from ethylenically unsaturated monomer compounds having anionic groups other than carboxyl groups such as sulfonic acid and phosphoric acid groups, and structural units derived from non-ionic ethylenically unsaturated monomers and the like. These structural units may be introduced by copolymerizing an ethylenically unsaturated monomer compound having anionic groups other than carboxyl groups such as sulfonic acid and phosphoric acid groups or a monomer containing a non-ionic ethylenically unsaturated monomer. Of these, a structural unit derived from a nonionic ethylenically unsaturated monomer is preferred as the component (b) for purposes of obtaining an electrode with good flex resistance, while (meth)acrylamide and its derivatives and the like are desirable for obtaining a binder with excellent binding ability. When a structural unit derived from a hydrophobic ethylenically unsaturated monomer with a solubility of not more than 1 g/100 ml in water is introduced as the component (b), moreover, it can interact strongly with the electrode materials, and exhibit good binding ability with the active material. This is desirable because a firm electrode mixture layer with good integrity can be obtained thereby. A structural unit derived from an ethylenically unsaturated monomer containing an alicyclic structure is particularly desirable.

The ratio of the component (b) may be from 0 mass % to 90 mass % of the total structural units of the crosslinked polymer. The ratio of the component (b) may also be from 1 mass % to 60 mass %, or from 2 mass % to 50 mass %, or from 5 mass % to 40 mass %, or from 10 mass % to 30 mass %. When the component (b) is included in the amount of not less than 1 mass % of the total structural units of the crosslinked polymer, the effect of improving lithium ion conductivity can also be expected because affinity with the electrolyte solution is improved.

Examples of (meth)acrylamide derivatives include N-alkyl (meth)acrylamide compounds such as isopropyl (meth)acrylamide, t-butyl (meth)acrylamide, N-n-butoxymethyl (meth)acrylamide and N-isobutoxymethyl (meth)acrylamide; and N,N-dialkyl (meth)acrylamide compounds such as dimethyl (meth)acrylamide and diethyl (meth)acrylamide, and one of these or a combination of two or more may be used.

Examples of ethylenically unsaturated monomers containing alicyclic structures include (meth)acrylic acid cycloalkyl esters optionally having aliphatic substituents, such as cyclopentyl (meth)acrylate, cyclohexyl (meth)acrylate, methyl cyclohexyl (meth)acrylate, t-butyl cyclohexyl (meth)acrylate, cyclodecyl (meth)acrylate and cyclododecyl (meth)acrylate; isobornyl (meth)acrylate, adamantyl (meth)acrylate, dicyclopentenyl (meth)acrylate, dicyclopentenyl oxyethyl (meth)acrylate and dicyclopentanyl (meth)acrylate; and cycloalkyl polyalcohol mono(meth)acrylates such as cyclohexane dimethanol mono(meth)acrylate and cyclodecane dimethanol mono(meth)acrylate, and one of these alone or a combination of two or more may be used. Of these, a compound having an acryloyl group as a polymerizable functional group is desirable for obtaining a binder with good binding ability because it has a rapid polymerization rate and yields a polymer with a long primary chain length.

A (meth)acrylic acid ester for example may also be used as a non-ionic ethylenically unsaturated monomer. Examples of (meth)acrylic acid esters include (meth)acrylic acid alkyl ester compounds such as methyl (meth)acrylate, ethyl (meth)acrylate, butyl (meth)acrylate, isobutyl (meth)acrylate and 2-ethylhexyl (meth)acrylate;

(meth)acrylic acid aralkyl ester compounds such as phenyl (meth)acrylate, phenylmethyl (meth)acrylate, phenylethyl (meth)acrylate;

(meth)acrylic acid alkoxy alkyl ester compounds such as 2-methoxyethyl (meth)acrylate and ethoxyethyl (meth)acrylate; and

(meth)acrylic acid hydroxyalkyl ester compounds such as hydroxyethyl (meth)acry late, hydroxypropyl (meth)acrylate and hydroxybutyl (meth)acrylate and the like, and one of these or a combination of two or more may be used. Considering the cycle characteristics and adhesiveness with the active material, a (meth)acrylic acid aralkyl ester compound can be used by preference.

Of these, compounds having ether bonds, including alkoxy alkyl (meth)acrylates such as 2-methoxyethyl (meth)acrylate and ethoxyethyl (meth)acrylate, are preferred for purposes of further improving lithium-ion conductivity and the high-rate characteristics, and 2-methoxyethyl (meth)acrylate is especially desirable.

Of the non-ionic ethylenically unsaturated monomers, a compound having an acryloyl group is preferred because the polymerization rate is faster, resulting in a polymer with a long primary chain length and a binder with good binding ability. To obtain an electrode with good flex resistance, the non-ionic ethylenically unsaturated monomer is preferably a compound with a glass transition temperature (Tg) of not more than 0° C. of the homopolymer.

The crosslinked polymer may also be in the form of a salt. The type of salt is not particularly limited, but examples include alkali metal salts such as lithium, sodium and potassium salts; alkali earth metal salts such as calcium and barium salts; other metal salts such as magnesium and aluminum salts; and organic amine salts such as ammonium salts and the like. Of these, alkali metal salts and magnesium salts are preferred because they are less likely to have an adverse effect on the battery characteristics, and an alkali metal salt is more preferred. A lithium salt is especially preferred because it yields a battery with low resistance.

(Embodiments of Crosslinked Polymer)

The crosslinking method in the crosslinked polymer of the teaching is not particularly limited, and examples include embodiments using the following crosslinking methods.

1) Copolymerization of crosslinkable monomers

2) Crosslinking using chain transfer to polymer chain during radical polymerization

3) Crosslinking after synthesis of polymer having reactive functional groups, and after addition of a crosslinking agent as necessary

Because the polymer has a crosslinked structure, a binder containing this polymer or a salt thereof can have excellent binding force. Of the methods listed above, a method involving copolymerization of crosslinkable monomers is preferred because the operations are simple and the degree of polymerization is easier to control.

(Crosslinkable Monomer)

Examples of crosslinkable monomers include polyfunctional polymerizable monomers having two or more polymerizable unsaturated groups, and monomers having self-crosslinkable functional groups such as hydrolysable silyl groups and the like.

The polyfunctional polymerizable monomers are compounds having two or more polymerizable functional groups such as (meth)acryloyl or alkenyl groups in the molecule, and examples include polyfunctional (meth)acrylate compounds, polyfunctional alkenyl compounds, and compounds having both (meth)acryloyl and alkenyl groups and the like. One of these compounds may be used alone, or a combination of two or more may be used. Of these, a polyfunctional alkenyl compound is preferred for ease of obtaining a uniform crosslinked structure, and a polyfunctional allyl ether compound having a plurality of allyl ether groups in the molecule is especially desirable.

Examples of polyfunctional (meth)acrylate compounds include di(meth)acrylates of dihydric alcohols, such as ethylene glycol di(meth)acrylate, propylene glycol di(meth)acrylate, 1,6-hexanediol di(meth)acrylate, polyethylene glycol di(meth)acrylate and polypropylene glycol di(meth)acrylate; tri(meth)acrylates of trihydric and higher polyhydric alcohols, such as trimethylolpropane tri(meth)acrylate, trimethylolpropane ethylene oxide modified tri(meth)acrylate, glycerin tri(meth)acrylate, pentaerythritol tri(meth)acrylate and pentaerythritol tetra(meth)acrylate; poly(meth)acrylates such as tetra(meth)acrylate and bisamides such as methylene bisacrylamide and hydroxyethylene bisacrylamide and the like.

Examples of polyfunctional alkenyl compounds include polyfunctional allyl ether compounds such as trimethylolpropane diallyl ether, trimethylolpropane triallyl ether, pentaerythritol diallyl ether, pentaerythritol triallyl ether, tetraallyl oxyethane and polyallyl saccharose; polyfunctional allyl compounds such as diallyl phthalate; and polyfunctional vinyl compounds such as divinyl benzene and the like.

Examples of compounds having both (meth)acryloyl and alkenyl groups include allyl (meth)acrylate, isopropenyl (meth)acrylate, butenyl (meth)acrylate, pentenyl (meth)acrylate and 2-(2-vinyloxyethoxy)ethyl (meth)acrylate and the like.

Specific examples of the monomers having self-crosslinkable functional groups include vinyl monomers containing hydrolysable silyl groups, and N-methylol (meth)acrylamide, N-methoxyalkyl (meth)acrylate and the like. One of these compounds or a mixture of two or more may be used.

The vinyl monomers containing hydrolysable silyl groups are not particularly limited as long as they are vinyl monomers having at least one hydrolysable silyl group. Examples include vinyl silanes such as vinyl trimethoxysilane, vinyl triethoxysilane, vinyl methyl dimethoxysilane and vinyl dimethyl methoxysilane; acrylic acid esters containing silyl groups, such as trimethoxysilylpropyl acrylate, triethoxysilylpropyl acrylate and methyl dimethoxysilylpropyl acrylate; methacrylic acid esters containing silyl groups, such as trimethoxysilylpropyl methacrylate, triethoxysilylpropyl methacrylate, methyl dimethoxysilylpropyl methacrylate and dimethyl methoxysilylpropyl methacrylate; vinyl ethers containing silyl groups, such as trimethoxysilylpropyl vinyl ether; and vinyl esters containing silyl groups, such as vinyl trimethoxysilyl undecanoate and the like.

When the crosslinked polymer is crosslinked with a crosslinkable monomer, the amount of the crosslinkable monomer used is preferably from 0.02 mol % to 0.7 mol %, or more preferably from 0.03 mol % to 0.4 mol % of the total amount of the monomers (non-crosslinkable monomers) other than the crosslinkable monomer. The amount of the crosslinkable monomer is preferably at least 0.02 mol % because this results in good binding ability and greater stability of the mixture layer slurry. If the amount is not more than 0.7 mol %, the crosslinked polymer tends to be more stable.

Furthermore, the amount of the crosslinkable monomer used is preferably from 0.05 mol % to 5 mass %, or more preferably from 0.1 mol % to 4 mass %, or still more preferably from 0.2 mol % to 3 mass %, or even more preferably from 0.3 mol % to 2 mass % of the total constituent monomers of the crosslinked polymer.

(Water Swelling Degree of Crosslinked Polymer)

In this Description, the water swelling degree is calculated by the following formula (1) from the weight [(WA) g] of the crosslinked polymer or salt thereof after drying and the amount of water [(WB) g] absorbed when the crosslinked polymer or salt thereof is saturated and swelled with water.

(Degree of water swelling)={(WA)+(WB)}/(WA) (1)

The water swelling degree of the crosslinked polymer or salt thereof at pH 8 is from 5.0 to 100. If the water swelling degree is within this range, sufficient adhesion areas with the active material and the collector can be ensured and good binding ability can be obtained when an electrode mixture layer is formed because the crosslinked polymer or salt thereof swells appropriately in an aqueous medium. This water swelling degree is preferably at least 6.0, or more preferably at least 8.0, or still more preferably at least 10, or yet more preferably at least 15, or even more preferably at least 20, or ideally at least 30. If the water swelling degree is less than 5.0, the crosslinked polymer or salt thereof is less likely to spread on the surface of the active material or collector, resulting in poor binding ability because the adhesion area is insufficient. The upper limit of the water swelling degree at pH 8 may be not more than 95, or not more than 90, or not more than 80. If the water swelling degree exceeds 100, a mixture layer composition (slurry) containing the crosslinked polymer or salt thereof tends to be more viscous, and sufficient binding force may not be obtained because the mixture layer is not sufficiently uniform. There is also a risk that the coating properties of the slurry will be reduced. The preferred range of the water swelling degree at pH 8 may be set by appropriately combining the above upper and lower limits, but may be from 6.0 to 100 for example, or from 10 to 100 for example, or from 20 to 95 for example.

The water swelling degree at pH 8 can be ascertained by measuring the swelling degree of the crosslinked polymer or salt thereof in pH 8 water. Ion-exchange water for example may be used as this pH 8 water, and the pH value thereof can be adjusted as necessary with a suitable acid, alkali or buffer solution or the like. The pH during measurement is in the range of 8.0±0.5, or preferably 8.0±0.3, or more preferably 8.0±0.2, or still more preferably 8.0±0.1.

The water swelling degree at pH 4 of the crosslinked polymer or salt thereof of the teaching may also be at least 2.0. The water swelling degree at pH 4 may also be at least 3.0, or at least 4.0, or at least 5.0, or at least 6.0. In general, the water swelling degree of the crosslinked polymer in the low pH range is lower than the water swelling degree in the high pH range. A binder containing a crosslinked polymer or salt thereof having a water swelling degree of at least 2.0 in the low pH range at pH 4 swells appropriately in an aqueous medium, and it is possible to secure an adequate adhesion area on the active material and collector and obtain good binding ability. The upper limit of the water swelling degree at pH 4 may be not more than 30, or not more than 25, or not more than 20, or not more than 15, or not more than 10.

The water swelling degree at pH 4 can be ascertained by measuring the swelling degree of the crosslinked polymer or salt thereof in pH 4 water. Phthalate pH standard solution for example may be used as this pH 4 water, and the pH value thereof can be adjusted as necessary with a suitable acid, alkali or buffer solution or the like. The pH during measurement is in the range of 4.0±0.5, or preferably 4.0±0.3, or more preferably 4.0±0.2, or still more preferably 4.0±0.1.

A person skilled in the art can adjust the water swelling degree by controlling the composition and structure and the like of the crosslinked polymer or salt thereof. For example, the water swelling degree can be increased by introducing an acidic functional group or a highly hydrophilic structural unit into the crosslinked polymer. The water swelling degree can also normally be increased by reducing the crosslinking degree of the crosslinked polymer.

(Particle Diameter of Crosslinked Polymer)

In order for a binder containing the crosslinked polymer to have good binding performance, it is desirable that the crosslinked polymer be properly dispersed in the form of water-swelled particles of a suitable particle diameter in the mixture layer composition, rather than existing as lumps (secondary aggregates) with a large particle diameter.

The particle diameter of the crosslinked polymer or salt thereof of the teaching when particles with a degree of neutralization of from 80 mol % to 100 mol % based on the carboxyl groups of the crosslinked polymer are dispersed in water (water-swelled particle diameter) is preferably a volume-based median diameter of from 0.1 μm to 15 μm. Excellent binding ability can be obtained if the particle diameter is from 0.1 μm to 15 μm because particles of a desirable size are uniformly present in the mixture layer composition, making the mixture layer composition highly stable. If the particle diameter exceeds 15 μm, the binding ability may be insufficient as discussed above. The coating properties may also be insufficient because it is difficult to obtain a smooth coated surface. If the particle diameter is less than 0.1 μm, on the other hand, stable manufacturing may be a concern. The lower limit of the particle diameter may be not less than 0.2 μm, or not less than 0.3 μm, or not less than 0.5 μm. The upper limit of the particle diameter may be not more than 12 μm, or not more than 10 μm, or not more than 7.0 μm, or not more than 5.0 μm, or not more than 3.0 μm. The range of the particle diameter may be set by appropriately combining these upper and lower limits, and may be from 0.1 μm to 10 μm for example, or from 0.2 μm to 5.0 μm for example, or from 0.3 μm to 3.0 μm for example.

The water-swelled particle diameter can be measured by the methods described in the examples of this Description.

When the crosslinked polymer is unneutralized or neutralized to a degree of less than 80 mol %, the particle diameter can be measured after the polymer has been neutralized to a degree of from 80 mol % to 100 mol % with an alkali metal hydroxide or the like and dispersed in water. In general, when a crosslinked polymer or salt thereof is in a powder or solution (dispersion) state the primary particles often combine to form aggregated massive particles. When the particle diameter in a water dispersed state is within the above range, this means that the crosslinked polymer or salt thereof has extremely good dispersibility, and massive particles are broken up when the polymer is neutralized to a degree of from 80 mol % to 100 mol % and dispersed in water, resulting in a roughly single-particle dispersion, or even if there are secondary aggregations, the polymer still forms a stable dispersed state with a particle diameter in the range of from 0.1 μm to 15 μm.

The particle size distribution obtained by dividing the volume-average particle diameter of the water-swelled particles by the number-average particle diameter is preferably not more than 10, or more preferably not more than 5.0, or still more preferably not more than 3.0, or yet more preferably not more than 1.5 from the standpoint of binding ability and coating properties. The lower limit of this particle size distribution is normally 1.0.

The particle diameter (dried particle diameter) of the crosslinked polymer or salt thereof of the teaching when dried is preferably a volume-based median diameter in the range of from 0.03 μm to 3 μm. The preferred range of this particle diameter is from 0.1 μm to 1 μm, or more preferably from 0.3 μm to 0.8 μm.

In the mixture layer composition, the crosslinked polymer or salt thereof is preferably used in the form of a salt in which the acid groups including carboxyl groups derived from the ethylenically unsaturated carboxylic acid monomer have been neutralized so that the degree of neutralization is from 20 mol % to 100 mol %. The degree of neutralization is more preferably from 50 mol % to 100 mol %, or still more preferably from 60 mol % to 95 mol %. A degree of neutralization of at least 20 mol % is desirable for obtaining good water swellability and a dispersion stabilization effect. In this Description, the degree of neutralization can be calculated from the input values of the monomers having acid groups such as carboxyl groups and the neutralizing agent used for neutralization. The degree of neutralization can be confirmed by drying the crosslinked polymer or salt thereof for 3 hours under reduced pressure conditions at 80° C., subjecting the resulting powder to IR measurement, and comparing the intensities of the peak derived from the C═O groups of the carboxylic acid and the peak derived from the C═O groups of the carboxylate.

(Molecular Weight (Primary Chain Length) of Crosslinked Polymer)

The crosslinked polymer of the teaching has a three-dimensional crosslinked structure and exists as a microgel in media such as water. Because such a three-dimensional crosslinked polymer is normal insoluble in solvents, its molecular weight cannot be measured. Similarly, it is normally also difficult to measure or assay the primary chain length of the crosslinked polymer.

(Method for Manufacturing Crosslinked Polymer or Salt Thereof)

A known polymerization method such as solution polymerization, precipitation polymerization, suspension polymerization or emulsification polymerization may be used for the crosslinked polymer, but precipitation polymerization and suspension polymerization (reverse-phase suspension polymerization) are preferred for reasons of productivity. To obtain better performance in terms of binding ability and the like, a heterogenous polymerization method such as precipitation polymerization, suspension polymerization or emulsion polymerization is preferred, and a precipitation polymerization method is especially preferred.

Precipitation polymerization is a method of manufacturing a polymer by performing a polymerization reaction in a solvent that dissolves the starting material (unsaturated monomer) but effectively does not dissolve the resulting polymer. As polymerization progresses, the polymer particles grow larger by aggregation and polymer growth, resulting in a dispersion of polymer particles micrometers to tens of micrometers in size formed by secondary aggregation of primary particles tens of nanometers to hundreds of nanometers in size. A dispersion stabilizer may also be used to control the particle size of the polymer.

Such secondary aggregation can also be suppressed by selecting the dispersion stabilizer, polymerization solvent and the like. In general, precipitation polymerization in which secondary aggregation is suppressed is referred to as dispersion polymerization.

In the case of precipitation polymerization, the polymerization solvent may be selected from water and various organic solvents and the like depending on the type of monomer used and the like. In order to easily obtain a polymer with a longer primary chain length, it is desirable to use a solvent with a small chain transfer constant.

Specific examples of polymerization solvents include water-soluble solvents such as methanol, t-butyl alcohol, acetone, methyl ethyl ketone, acetonitrile and tetrahydrofuran, and benzene, ethyl acetate, dichloroethane, n-hexane, cyclohexane and n-heptane and the like, and one of these or a combination of two or more may be used. Mixed solvents of these with water may also be used. In the present teaching, a water-soluble solvent is one having a solubility of more than 10 g/100 ml in water at 20° C.

Of these solvents, methyl ethyl ketone and acetonitrile are preferred because, for example, polymerization stability is good, with less production of coarse particles and adhesion to the reaction vessel, because the precipitated polymer fine particles are less liable to secondary aggregation (or any secondary aggregates that occur are easily broken up in an aqueous medium), because the chain transfer constant is low, resulting in a polymer with a high degree of polymerization (long primary chain length), and because the operation is easier in the process neutralization described below.

To achieve a stable and rapid neutralization reaction during this process neutralization, moreover, it is desirable to add a small amount of a high polar solvent to the polymerization solvent. Desirable examples of this highly polar solvent are water and methanol. The amount of the highly polar solvent used is preferably from 0.05 mass % to 20.0 mass %, or more preferably from 0.1 mass % to 10.0 mass %, or still more preferably from 0.1 mass % to 5.0 mass %, or yet more preferably from 0.1 mass % to 1.0 mass % based on the total mass of the medium. If the ratio of the highly polar solvent is at least 0.05 mass %, the effect on the neutralization reaction is achieved, while if it is not more than 20.0 mass %, there is no adverse effect on the polymerization reaction. When polymerizing a highly hydrophilic ethylenically unsaturated carboxylic acid monomer such as acrylic acid, moreover, adding a highly polar solvent serves to increase the polymerization rate and make it easier to obtain a polymer with a long primary chain length. Of the highly polar solvents, water in particular is desirable because it has a strong improvement effect on the polymerization rate.

The manufacture of the crosslinked polymer or salt thereof preferably includes a polymerization step in which monomer components including an ethylenically unsaturated carboxylic acid monomer are polymerized. For example, it may include a polymerization step in which from 10 mass % to 100 mass % of an ethylenically unsaturated carboxylic acid monomer as a source of the component (a) and from 0 mass % to 90 mass % of another ethylenically unsaturated monomer as a source of the component (b) are polymerized.

From 10 mass % to 100 mass % of a structural unit derived from an ethylenically unsaturated carboxylic acid monomer is introduced into the crosslinked polymer by this polymerization step. The amount of the ethylenically unsaturated carboxylic acid monomer used may also be from 20 mass % to 100 mass % for example, or from 30 mass % to 100 mass % for example, or from 50 mass % to 100 mass % for example.

Examples of the other ethylenically unsaturated monomer include for example ethylenically unsaturated monomer compounds having anionic groups other than carboxylic acid groups, such as sulfonic acid groups or phosphoric acid groups, as well as nonionic ethylenically unsaturated monomers and the like. Examples of specific compounds include monomer compounds capable of introducing the component (b) described above. This other ethylenically unsaturated monomer may be contained in the amount of from 0 mass % to 90 mass %, or from 1 mass % to 60 mass %, or from 5 mass % to 50 mass %, or from 10 mass % to 30 mass % of the total amount of the monomer components. The crosslinkable monomer described above may also be used in the same manner.

The monomer concentration during polymerization is preferably high in order to easily obtain a polymer with a long primary chain length. If the monomer concentration is too high, however, agglomeration of the polymer particles progresses more easily, and there is a risk of a runaway polymerization reaction because it is difficult to control the polymerization heat. Consequently, in the case of a precipitation polymerization method for example, the monomer concentration at the start of polymerization is normally in the range of about from 2 mass % to 40 mass %, or preferably from 5 mass % to 40 mass %.

In this Description, the “monomer concentration” is the concentration of monomers in the reaction solution at the point when polymerization begins.

The crosslinked polymer may also be manufactured by performing a polymerization reaction in the presence of a basic compound. By performing a polymerization reaction in the presence of a basic compound, it is possible to stably perform a polymerization reaction even under high monomer concentration conditions. The monomer concentration may be at least 13.0 mass %, or preferably at least 15.0 mass %, or more preferably at least 17.0 mass %, or still more preferably at least 19.0 mass %, or yet more preferably at least 20.0 mass %. Still more preferably the monomer concentration is at least 22.0 mass %, or even more preferably at least 25.0 mass %. In general, the molecular weights can be higher the higher the monomer concentration during polymerization, and a polymer with a long primary chain length can be manufactured.

The maximum monomer concentration differs depending on the types of monomers and solvents used, the polymerization method and the various polymerization conditions and the like, but if the heat of the polymerization reaction can be removed, the maximum is about 40 mass % in the case of precipitation polymerization as discussed above, or about 50 mass % in the case of suspension polymerization, or about 70 mass % in the case of emulsion polymerization.

The basic compound is a so-called alkaline compound, and either an inorganic basic compound or an organic basic compound may be used. By performing a polymerization reaction in the presence of a basic compound, it is possible to stably perform a polymerization reaction even under high monomer concentration conditions in excess of 13.0 mass % for example. Moreover, a polymer obtained by polymerization at such a high monomer concentration is desirable from the standpoint of binding ability because it generally has a high molecular weight (a long primary chain length).

Examples of inorganic basic compounds include alkali metal hydroxides such as lithium hydroxide, sodium hydroxide and potassium hydroxide, and alkali earth metal hydroxides such as calcium hydroxide and magnesium hydroxide, and one or two or more kinds of these may be used.

Examples of organic basic compounds include ammonia and organic amine compounds, and one or two or more kinds of these may be used. Of these, an organic amine compound is desirable from the standpoint of polymerization stability and the binding ability of a binder containing the resulting crosslinked polymer or a salt thereof.

Examples of organic amine compounds include N-alkyl substituted amines such as monomethylamine, dimethylamine, trimethylamine, monoethylamine, diethylamine, triethylamine, monobutylamine, dibutylamine, trbutylamine, monohexylamine, dihexylamine, trihexylamine, trioctylamine and tridodecylamine; (alkyl) alkanolamines such as monoethanolamine, diethanolamine, triethanolamine, propanolamine, dimethylethanolamine and N,N-dimethylethanolamine; cyclic amines such as pyridine, piperidine, piperazine, 1,8-bis(dimethylamino)naphthalene, morpholine and diazabicycloundecene (DBU); and diethylene triamine and N,N-dimethylbenzylamine, and one or two or kinds of these may be used.

Of these, a hydrophobic amine having a long-chain alkyl group is preferred for ensuring polymerization stability even at high monomer concentrations because it generates greater electrostatic and steric repulsion. Specifically, the polymerization stabilization effect due to steric repulsion is greater the higher the value (C/N) representing the ratio of the number of carbon atoms to the number of nitrogen atoms in the organic amine compound. The value of C/N is preferably at least 3, or more preferably at least 5, or still more preferably at least 10, or yet more preferably at least 20.

An amine compound with a high C/N value is normally a highly hydrophobic compound with a low amine value. As discussed above, an amine compound with a high C/N value tends to exhibit a strong polymerization stabilization effect, and because the monomer concentration can be raised during polymerization, the molecular weight (primary chain length) of the polymer is increased, which tends to improve binding ability. When polymerization is performed in the presence of an amine compound with a high C/N value, moreover, it tends to yield a crosslinked polymer or salt thereof with a small particle diameter.

During polymerization, a basic compound is preferably used in the amount of at least 0.001 mol % of the above ethylenically unsaturated carboxylic acid monomer. By performing a polymerization reaction in the presence of at least 0.001 mol % of a basic compound, it is possible to improve the polymerization stability, and promote a smooth polymerization reaction even under high monomer concentration conditions. The amount of the basic compound used relative to the ethylenically unsaturated carboxylic acid monomer is preferably at least 0.01 mol %, or more preferably at least 0.03 mol %, or still more preferably at least 0.05 mol %. The amount of the basic compound used may also be at least 0.3 mol %, or at least 0.5 mol %.

The maximum amount of the basic compound used is preferably not more than 4.0 mol %. By performing a polymerization reaction in the presence of not more than 4.0 mol % of a basic compound, it is possible to improve the polymerization stability, and promote a smooth polymerization reaction even under high monomer concentration conditions. The amount of the basic compound used relative to the ethylenically unsaturated carboxylic acid monomer is preferably not more than 3.0 mol %, or more preferably not more than 2.0 mol %, or still more preferably not more than 1.0 mol %.

In this Description, the amount of the basic compound used represents the molar concentration of the basic compound used relative to the ethylenically unsaturated carboxylic acid monomer, not the degree of neutralization. In other words, the valence of the basic compound used is not considered.

A known polymerization initiator such as an azo compound, organic peroxide or inorganic peroxide may be used as a polymerization initiator, without any particular restrictions. The conditions of use may be adjusted to achieve a suitable amount of radical generation, using a known method such as thermal initiation, redox initiation using a reducing agent, UV initiation or the like. To obtain a crosslinked polymer with a long primary chain length, the conditions are preferably set so as to reduce the amount of radical generation within the allowable range of manufacturing time.

Examples of the azo compound include 2,2′-azobis(2,4-dimethylvaleronitrile), 2,2′-azobis(N-butyl-2-methylpropionamide), 2-(tert-butylazo)-2-cyanopropane, 2,2′-azobis(2,4,4-trimethylpentane) and 2,2′-azobis(2-methylpropane), and one of these or a combination of two or more may be used.

Examples of the organic peroxide include 2,2-bis(4,4-di-t-butylperoxycyclohexyl) propane (product name “Pertetra A” by NOF Corporation), 1,1-di(t-hexylperoxy) cyclohexane (product name “Perhexa HC” by NOF Corporation), 1,1-di(t-butylperoxy) cyclohexane (product name “Perhexa C” by NOF Corporation), n-butyl-4,4-di(t-butylperoxy) valerate (product name “Perhexa V” by NOF Corporation), 2,2-di(t-butylperoxy)butane (product name “Perhexa 22” by NOF Corporation), t-butylhydroperoxide (product name “Perbutyl H” by NOF Corporation), cumene hydroperoxide (product name “Percumyl H” by NOF Corporation), 1,1,3,3-tetramethylbutyl hydroperoxide (product name “ Perocta H” by NOF Corporation), t-butylcumyl peroxide (product name “Perbutyl C” by NOF Corporation), di-t-butyl peroxide (product name “Perbutyl D” by NOF Corporation), di-t-hexyl peroxide (product name “Perhexyl D” by NOF Corporation), di(3,5,5-trimethylhexanoyl) peroxide (product name “Peroyl 355” by NOF Corporation), dilauroyl peroxide (product name “Peroyl L” by NOF Corporation), bis(4-t-butylcyclohexyl) peroxydicarbonate (product name “Peroyl TCP” by NOF Corporation), di-2-ethylhexyl peroxydicarbonate (product name “Peroyl OPP” by NOF Corporation), di-sec-butyl peroxydicarbonate (product name “Peroyl SBP” by NOF Corporation), cumyl peroxyneodecanoate (product name “Percumyl ND” by NOF Corporation), 1,1,3,3-tetramethylbutyl peroxyneodecanoate (product name “Perocta ND” by NOF Corporation), t-hexyl peroxyneodecanoate (product name “Perhexyl ND” by NOF Corporation), t-butyl peroxyneodecanoate (product name “Perbutyl ND” by NOF Corporation), t-butyl peroxyneoheptanoate (product name “Perbutyl NHP” by NOF Corporation), t-hexyl peroxypivalate (product name “Perhexyl PV” by NOF Corporation), t-butyl peroxypivalate (product name “Perbutyl PV” by NOF Corporation), 2,5-dimethyl-2,5-di(2-ethylhexanoyl) hexane (product name “Perhexa 250” by NOF Corporation), 1,1,3,3-tetramethylbutylperoxy-2-ethylhexanoate (product name “Perocta O” by NOF Corporation), t-hexylperoxy-2-ethylhexanoate (product name “Perhexyl O” by NOF Corporation), t-butylperoxy-2-ethylhexanoate (product name “Perbutyl O” by NOF Corporation), t-butyl peroxylaurate (product name “Perbutyl L” by NOF Corporation), t-butyl peroxy-3,5,5-trimethylhexanoate (product name “Perbutyl 355” by NOF Corporation), t-hexylperoxyisopropyl monocarbonate (product name “Perhexyl I” by NOF Corporation), t-butylperoxyisopropyl monocarbonate (product name “Perbutyl I” by NOF Corporation), t-butyl-oxy-2-ethyl hexyl monocarbonate (product name “Perbutyl E” by NOF Corporation), t-butyl peroxyacetate (product name “Perbutyl A” by NOF Corporation), t-hexyl peroxybenzoate (product name “Perhexyl Z” by NOF Corporation) and t-butyl peroxybenzoate (product name “Perbutyl Z” by NOF Corporation) and the like. One of these or a combination of two or more may be used.

Examples of the inorganic peroxide include potassium persulfate, sodium persulfate and ammonium persulfate.

When using a redox initiator, sodium sulfite, sodium thiosulfate, sodium formaldehyde sulfoxylate, ascorbic acid, sulfite gas (SO₂), ferrous sulfate or the like can be used as the reducing agent.

The polymerization initiator is preferably used in the amount of, for example from 0.001 mass parts to 2 mass parts, or for example from 0.005 mass parts to 1 mass parts, or for example from 0.01 mass parts to 0.1 mass parts given 100 mass parts as the total amount of the monomer components used. If the amount of the polymerization initiator is at least 0.001 mass parts, a stable polymerization reaction can be achieved, while if it is not more than 2 mass parts a polymer with a long primary chain length can be easily obtained.

The polymerization temperature depends on the conditions such as the type and concentration of the monomer used, but is preferably from 0° C. to 100° C. or more preferably from 20° C. to 80° C. The polymerization temperature may be constant, or may vary during the course of the polymerization reaction. The polymerization time is preferably from 1 minute to 20 hours, or more preferably from 1 hour to 10 hours.

The target crosslinked polymer may be obtained in a powder state by applying reduced pressure and/or heat treatment or the like in a drying step to remove the solvent from the crosslinked polymer dispersion obtained through the polymerization step. In this case, a solid-liquid separation step by centrifugation and filtration or the like, and a washing step using water, methanol, or the same solvent as the polymerization solvent or the like, are preferably provided after the polymerization step with the aim of removing unreacted monomers (and their salts) and impurities derived from initiators and the like before the drying step. When the washing step is included, even if the crosslinked polymer has undergone secondary aggregation the aggregates are easily broken up, and good performance is obtained in terms of binding ability and battery characteristics because any remaining unreacted monomers are removed.

In this manufacturing method, a monomer composition containing an ethylenically unsaturated carboxylic acid monomer is subjected to a polymerization reaction in the presence of a basic compound, but an alkali compound may also be added to the polymer dispersion obtained by the polymerization step to neutralize the polymer (hereunder called “process neutralization”) before removing the solvent in the drying step. Alternatively, a powder of the crosslinked polymer may be obtained without performing such process neutralization, and an alkali compound may then be added to neutralize the polymer when preparing the electrode mixture layer slurry (hereunder called “post-neutralization”). Of these, process neutralization is preferred because it tends to make the secondary aggregates easier to break up.

(Electrode Mixture Layer Composition for a Secondary Battery)

The electrode mixture layer composition for a secondary battery of the present teaching contains a binder containing the crosslinked polymer or salt thereof, together with an active material and water.

The amount of the crosslinked polymer or salt thereof used in the electrode mixture layer composition of the present teaching is, for example, from 0.1 mass % to 20 mass %, or for example, from 0.2 mass % to 10 mass %, or for example, from 0.3 mass % to 8 mass %, or for example, from 0.4 mass % to 5 mass % of the total amount of the active material. If the amount of the crosslinked polymer or salt thereof is less than 0.1 mass %, sufficient binding ability may not be obtained. Moreover, dispersion stability of the active material and the like may be inadequate, detracting from the uniformity of the formed mixture layer. If the amount of the crosslinked polymer or salt thereof exceeds 20 mass %, on the other hand, the electrode mixture layer composition may become highly viscous, and coating performance on the collector may decrease. Consequently, spots and irregularities may occur in the resulting mixture layer, adversely affecting the electrode characteristics.

If the amount of the crosslinked polymer and salt thereof is within the aforementioned range, a composition with excellent dispersion stability can be obtained, and it is also possible to obtain a mixture layer with extremely high adhesiveness to the collector, resulting in improved battery durability. Moreover, because the crosslinked polymer and salt thereof has sufficient ability to bind the active material even in a small quantity (such as 5 mass % or less), and because it has carboxy anions, it can yield an electrode with little interface resistance and excellent high-rate characteristics.

Of the active materials described above, lithium salts of transition metal oxides may be used as positive electrode active materials, and for example laminar rock salt-type and spinel-type lithium-containing metal oxides may be used. Specific compounds that are laminar rock salt-type positive electrode active materials include lithium cobaltate, lithium nickelate, and NCM {Li(Niₓ,Co_{y},Mn_{z}), x+y+z=1} and NCA {Li(Ni_{1-a-b}CoₐAl_{b})} and the like, which are referred to as ternary materials. Examples of spinel-type positive electrode active materials include lithium manganate and the like. Apart from oxides, phosphate salts, silicate salts and sulfur and the like may also be used. Examples of phosphate salts include olivine-type lithium iron phosphate and the like. One of these may be used alone as a positive electrode active material, or two or more may be combined and used as a mixture or composite.

When a positive electrode active material containing a laminar rock salt-type lithium-containing metal oxide is dispersed in water, the dispersion exhibits alkalinity because the lithium ions on the surface of the active material are exchanged for hydrogen ions in the water. There is thus the risk of corrosion of aluminum foil (Al) or the like, which is a common positive electrode collector material. In such cases, it is desirable to neutralize the alkali component eluted from the active material by using an unneutralized or partially neutralized crosslinked polymer as the binder. The amount of the unneutralized or partially neutralized crosslinked polymer used is preferably such that the amount of unneutralized carboxyl groups in the crosslinked polymer is at least equivalent to the amount of alkali eluted from the active material.

Because all the positive electrode active materials have low electrical conductivity, a conductive aid is normally added and used. Examples of conductive aids include carbon materials such as carbon black, carbon nanotubes, carbon fiber, graphite fine powder, and carbon fiber. Of these, carbon black, carbon nanotubes and carbon fiber are preferred to make it easier to obtain excellent conductivity. As the carbon black, ketjen black and acetylene black are preferable. One of these conductive aids may be used alone, or a combination of two or more may be used. The amount of the conductive aid used may be, for example, from 0.2 mass % to 20 mass %, or for example, from 0.2 mass % to 10 mass % of the total amount of the active material in order to achieve both conductivity and energy density. The positive electrode active material may also be a conductive carbon material that has been surface coated.

Examples of negative electrode active materials include carbon materials, lithium metal, lithium alloys, metal oxides and the like, and one of these or a combination of two or more may be used. Of these, an active material formed of a carbon material such as natural graphite, artificial graphite, hard carbon, and soft carbon (hereunder referred to as a “carbon-based active material”) is preferred, and hard carbon or a graphite such as natural graphite or artificial graphite is more preferred. In the case of graphite, spheroidized graphite is desirable from the standpoint of battery performance, and the particle size thereof is in the range of, for example, from 1 μm to 20 μm, or for example, 5 μm to 15 μm. To increase the energy density, metals, metal oxides or the like capable of occluding lithium, such as silicon and tin, can also be used as negative electrode active materials. Of these, silicon has a higher capacity than graphite, and an active material formed of a silicon material such as silicon, a silicon alloy or a silicon oxide such as silicon monoxide (SiO) (hereunder referred to as a “silicon-based active material”) may be used. Although these silicon-based active materials have high capacities, however, the volume change accompanying charging and discharging is large. Therefore, they are preferably used in combination with the aforementioned carbon-based active materials. In this case, a large compounded amount of the silicon active material can cause breakdown of the electrode material, greatly detracting from the cycle characteristics (durability). From this perspective, when a silicon-based active material is included the amount thereof is, for example, not more than 60 mass %, or for example, not more than 30 mass % of the amount of the carbon-based active material.

In the binder containing a crosslinked polymer of the present teaching, the crosslinked polymer has a structural unit (component (a)) derived from an ethylenically unsaturated carboxylic acid monomer. The component (a) here has strong affinity for silicon active materials and exhibits good binding ability. It is thought that because of this, the binder of the teaching is effective for improving the durability of the resulting electrode because exhibits excellent binding ability even when used with a high-capacity type active material containing a silicon active material.

Because carbon-based active materials themselves have good electrical conductivity, it may not be necessary to add a conductive aid. When a conductive aid is added to further reduce resistance or the like, the amount thereof is, for example, not more than 10 mass %, or for example, not more than 5 mass % of the total amount of the active material from the standpoint of energy density.

When the electrode mixture layer composition for a secondary battery is in slurry form, the amount of the active material used is in the range of, for example, from 10 mass % to 75 mass %, or for example, from 30 mass % to 65 mass % of the total amount of the composition. An amount of the active material of at least 10 mass % is advantageous for suppressing migration of the binder and the like, and also because of the drying costs of the medium. If the amount is not more than 75 mass %, on the other hand, it is possible to ensure the flowability and coating performance of the composition, and to form a uniform mixture layer.

When the electrode mixture layer composition is prepared in a wet powder state, the amount of the active material used is in the range of, for example, from 60 mass % to 97 mass %, or for example, from 70 mass % to 90 mass % of the total amount of the composition. From the standpoint of energy density, the non-volatile components other than the active material, such as the binder and conductive aid, are preferably used in the smallest amounts possible while maintaining binding ability and conductivity.

The secondary battery electrode mixture layer composition uses water as a medium. To adjust the properties such as drying properties of the composition, it is also possible to use a mixed solvent of water with a water-soluble organic solvent, which may be a lower alcohol such as methanol or ethanol, a carbonate such as ethylene carbonate, a ketone such as acetone, or tetrahydrofuran, N-methylpyrrolidone or the like. The percentage of water in the mixed solvent is, for example, at least 50 mass %, or for example, at least 70 mass %.

When the electrode mixture layer composition is in a coatable slurry form, the content of the media including water as a percentage of the total composition may be in the range of, for example, from 25 mass % to 90 mass %, or for example, from 35 mass % to 70 mass % from the standpoint of the slurry coating properties, the energy costs required for drying, and productivity. If the electrode mixture layer composition is in a wet powder form that can be pressed, the content of the media may be, for example, from 3 mass % to 40 mass % or for example, from 10 mass % to 30 mass % from the standpoint of obtaining evenness in the mixture layer after pressing.

The binder of the present teaching may be formed solely of the crosslinked polymer or salt thereof, but this may also be combined with another binder component such as styrene/butadiene latex (SBR), acrylic latex, and polyvinylidene fluoride latex. In addition, carboxymethyl cellulose (CMC) and its derivatives may also be used. When these binder components are included, the amount thereof may be, for example, from 0.1 mass % to 5 mass % , or for example, from 0.1 mass % to 2 mass %, or for example, from 0.1 mass % to 1 mass %, of the active material. If the amount of the other binder component exceeds 5 mass %, resistance increases, and the high-rate characteristics may become insufficient. Of the above, styrene/butadiene latex is preferred from the standpoint of balancing binding ability and flex resistance.

This styrene/butadiene latex is an aqueous dispersion of a copolymer having a structural unit derived from an aromatic vinyl monomer such as styrene and a structural unit derived from an aliphatic conjugated diene monomer such as 1,3-butadiene. Examples of the aromatic vinyl monomer include α-methylstyrene, vinyltoluene and divinylbenzene as well as styrene, and one of these or two or more may be used. The structural unit derived from the aromatic vinyl monomer in the copolymer described above may constitute, for example, from 20 mass % to 60 mass %, or for example, from 30 mass % to 50 mass % of the copolymer from the standpoint of binding ability primarily.

Examples of the aliphatic conjugated diene monomer include 2-methyl-1,3-butadiene, 2,3-dimethyl-1,3-butadiene and 2-chloro-1,3-butadiene as well as 1,3-butadiene, and one of these or two or more may be used. The structural unit derived from the aliphatic conjugated diene monomer may constitute, for example, from 30 mass % to 70 mass %, or for example, from 40 mass % to 60 mass % of the copolymer from the standpoint of the binding ability of the binder and the flexibility of the resulting electrode.

To further improve binding performance and the like, the styrene/butadiene latex may also use a nitrile group-containing monomer such as (meth)acrylonitrile or a carboxyl group-containing monomer such as (meth)acrylic acid, itaconic acid or maleic acid as a copolymerized monomer in addition to the monomers described above.

The structural unit derived from this other monomer may be contained in the copolymer in the amount of, for example, from 0 mass % to 30 mass %, or for example, from 0 mass % to 20 mass %.

The secondary battery electrode mixture layer composition of the teaching has the above active material, water and a binder as essential components, and is obtained by mixing these components by known methods. The methods of mixing the individual components are not particularly limited, and known methods may be used, but in a preferred method the powder components including the active material, conductive aid and binder (crosslinked polymer particle) are dry blended, and then mixed with a dispersion medium such as water and dispersed and kneaded. When the electrode mixture layer composition is obtained in slurry form, it is preferably refined into a slurry without dispersion defects or agglomeration. The mixing method may be one using a known mixer such as a planetary mixer, thin film swirling mixer or self-revolving mixer, and a thin film swirling mixer is preferred for obtaining a good dispersed state in a short time. When a thin film swirling mixer is used, pre-dispersion is preferably performed in advance with a Disper or other stirring device.

The viscosity of the slurry may be in the range of, for example, from 500 mPa·s to 100,000 mPa·s, or for example, from 1,000 mPa·s to 50,000 mPa·s (B type viscosity at 60 rpm).

When the electrode mixture layer composition is obtained as a wet powder, it is preferably kneaded with a Henschel mixer, blender, planetary mixer or twin-screw kneader or the like to obtain a uniform state without concentration irregularities.

(Secondary Battery Electrode)

The secondary battery electrode of the present teaching is provided with a mixture layer formed from the electrode mixture layer composition on the surface of a collector such as a copper or aluminum collector. The mixture layer is formed by first coating the electrode mixture layer composition of the present teaching on the surface of the collector, and then drying to remove the water or other medium. The method of coating the mixture layer composition is not particularly limited, and a known method such as a doctor blade method, dipping, roll coating, comma coating, curtain coating, gravure coating or extrusion may be adopted. The drying may also be accomplished by a known method such as warm air blowing, pressure reduction, (far) infrared exposure or microwave exposure.

The mixture layer obtained after drying is normally subjected to compression treatment with a metal press, roll press or the like. By compressing, the active material and the binder are brought into close contact with each other, and the strength of the mixture layer and the adhesion to the collector can be improved. Compression may reduce the thickness of the mixture layer to, for example, about from 30% to 80% of the pre-compression thickness, and the thickness of the mixture layer after compression is normally about from 4 μm to 200 μm.

A secondary battery can be prepared by providing a separator and an electrolyte solution with the secondary battery electrode of the present teaching. The electrolyte solution may be in liquid form or in gel form.

The separator is disposed between the positive and negative electrodes of the battery, and serves to prevent short-circuits due to contact between the electrodes, hold the electrolyte solution and ensure ion conductivity. The separator is an insulating finely porous film, and preferably has good ion permeability and mechanical strength. Specific materials that can be used include polyolefins such as polyethylene and polypropylene, and polytetrafluoroethylene and the like.

For the electrolyte solution, a known electrolyte solution commonly used can be used in accordance with the type of active materials. For lithium ion secondary batteries, specific examples of the solvent include cyclic carbonates with high dielectric constants and good ability to dissolve electrolytes, such as propylene carbonate and ethylene carbonate, and linear carbonates with low viscosity, such as ethyl methyl carbonate, dimethyl carbonate and diethyl carbonate, and these may be used alone or as a mixed solvent. A lithium salt such as LiPF₆, LiSbF₆, LiBF₄, LiClO₄ or LiAlO₄ is dissolved in this solvent and used as the electrolyte solution. In a nickel-hydride secondary battery, a potassium hydroxide aqueous solution may be used as the electrolyte solution. The secondary battery is obtained by making the positive electrode plate and negative electrode plate into a spiral or laminate structure with a separator between the two and enclosing this structure in a case or the like.

As explained above, because the binder for a secondary battery electrode disclosed here exhibits excellent binding ability with the electrode material in the mixture layer and excellent adhesiveness with the collector, a secondary battery provided with an electrode obtained using this binder can ensure good integrity and is expected to provide good durability (cycle characteristics) even after repeated charging and discharging, making it ideal for rechargeable vehicle batteries and the like.

### EXAMPLES

The present teaching is described in detail below based on examples. However, the present teaching is not limited by these examples. In the following, “parts” and “%” mean parts by mass and % by mass unless otherwise specified.

In the examples below, the crosslinked polymer (salt) was evaluated by the following methods.

(1) Measuring Average Particle Diameter in Aqueous Medium (Water-Swelled Particle Diameter)

0.25 g of a powder of the crosslinked polymer salt and 49.75 g of ion exchange water were measured into a 100 cc container, which was then set in a rotating/revolving mixer (“Awatori Rentaro AR-250” by Thinky Corporation). This was then stirred (rotating speed 2,000 rpm/revolving speed 800 rpm, 7 minutes), and then defoamed (rotating speed 2,200 rpm/revolving speed 60 rpm, 1 minute) to prepare a hydrogel of the crosslinked polymer salt in a water-swelled state.

Next, the particle size distribution of this hydrogel was measured with a laser diffraction/scattering type particle size distribution analyzer (Microtrac MT-3300EX2 manufactured by MicrotracBEL) using ion exchange water as the dispersion medium. When enough hydrogel to obtain a suitable scattered light intensity was injected with the dispersion medium circulating in an excess amount relative to the hydrogel, the measured particle size distribution shape stabilized after a few minutes. Once stability was confirmed, particle size distribution measurement was performed, and the volume-based median diameter (D50) was obtained as the average particle diameter along with the particle size distribution represented by (volume-average particle diameter)/(number-average particle diameter).

(2) Water Swelling Degree at pH 8

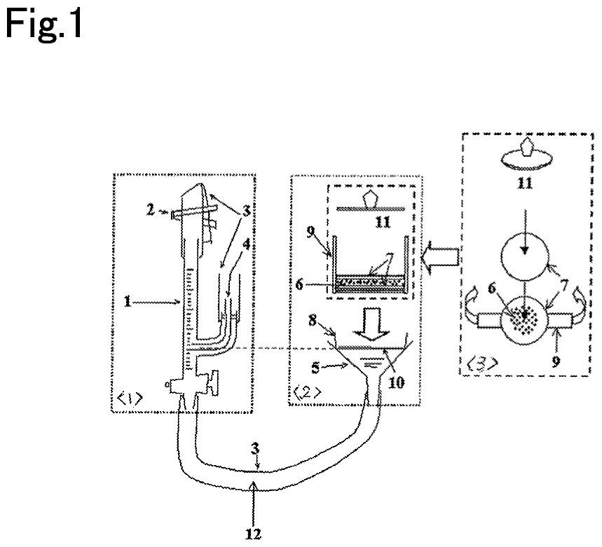

The water swelling degree at pH 8 was measured by the following methods. The measurement apparatus is shown in FIG. 1.

The measurement apparatus comprises <1> to <3> in FIG. 1.

<1> Consisting of burette 1 with attached branch pipe for venting air, pinch cock 2, silicone tube 3, and polytetrafluoroethylene tube 4.

<2> Support cylinder 8 with multiple holes in the bottom on top of funnel 5, with filter paper 10 for apparatus set on top of the cylinder.

<3> Sample 6 of crosslinked polymer or salt thereof (measurement sample) is sandwiched between two sample-fixing filter papers 7, and the sample-fixing filter papers are fixed with adhesive tape 9. Advantec No. 2 filter paper with an internal diameter of 55 mm was used for all of the filter paper.

<1> and <2> are connected by the silicone tube 3.

The heights of the funnel 5 and support cylinder 8 are fixed relative to the burette 1, and the lower end of the polytetrafluoroethylene tube 4 installed inside the burette branch pipe is set so as to be at the same height as the lower surface of the support cylinder 8 (dotted line in FIG. 1).

The measurement methods are explained below.

The pinch cock 2 in <1> is removed, and ion exchange water is poured through the silicone tube 3 from the top of the burette 1 to fill the apparatus with the ion exchange water 12 from the burette 1 up to the filter paper 10 for the apparatus. The pinch cock 2 is then closed, and air is removed from the polytetrafluoroethylene tube 4, which is connected to the burette branch tube by a rubber stopper. The ion exchange water 12 is thus continuously supplied from the burette 1 to the filter paper 10 for the apparatus.

Next, the excess ion exchange water 12 oozing out of the filter paper 10 for the apparatus is removed, after which the scale reading (a) of the burette 1 is recorded.

0.1 to 0.2 g of a dried powder of the measurement sample is weighed and placed uniformly in the center of a sample-fixing filter paper 7 as shown in <3>. The sample is sandwiched with another sheet of filter paper, and the two sheets of filter paper are fastened together with the adhesive tape 9 to fix the sample. The filter paper with the fixed sample is mounted on the filter paper for the apparatus as shown in <2>.

Once the lid 11 has been placed on the filter paper 10 for the apparatus, the scale reading (b) of the burette 1 is recorded after 30 minutes.

The total (c) of the water absorption by the measurement sample and the water absorption by the two sheets of sample-fixing filter paper 7 is determined as (a−b). The water absorption (d) by the two sheets of filter paper 7 alone is also measured by the same operation without including any sample of the crosslinked polymer or salt thereof.

These operations are performed, and the water swelling degree is calculated by the following formula. The solids component used in calculation is a value measured by the methods of (4) below.

Water swelling degree={dried weight (g) of measurement sample+(c−d)}/{dried weight (g) of measurement sample}

The dried weight (g) of the measurement sample is calculated as the weight (g) of the measurement sample x (solids %÷100).

(3) Degree of Water Swelling at pH 4

The water swelling degree at pH 4 is measured by the same operations used to measure the water swelling degree at pH 8 in (3) above except that a phthalate pH standard solution is used instead of ion exchange water.

(4) Solids Component

The measurement methods are described below.

About 0.5 g of the sample is collected in a weighing bottle that has been weighed in advance [weight of weighing bottle=B (g)] and weighed accurately together with the weighing bottle [W₀ (g)], the sample is enclosed together with the weighing bottle in a windless dryer and dried for 45 minutes at 155° C. and then weighed at that point together with the weighing bottle [W₁ (g)], and the solids% is calculated according to the following formula.

Solids (NV) (%)={(W₀−B)−(W₁−B)}×100

(Manufacturing Crosslinked Polymer Salt)

### Manufacturing Example 1: Manufacturing Crosslinked Polymer Salt R-1

A reactor equipped with a stirring blade, a thermometer, a reflux condenser and a nitrogen inlet pipe was used for polymerization.

567 parts of acetonitrile, 2.20 parts of ion exchange water, 100 parts of acrylic acid (hereunder called “AA”), 0.10 parts of pentaerythritol triallyl ether (Neoallyl P-30, manufactured by Daiso Co., Ltd.) and trioctylamine corresponding to 1.0 mol % of the AA above were loaded into a reactor. The inside of the reactor was thoroughly purged with nitrogen, and heated to raise the internal temperature to 55° C. Once the internal temperature was confirmed to have stabilized at 55° C., 0.040 parts of 2,2′-azobis(2,4-dimethylvaleronitrile) (product name “V-65” by Wako Pure Chemical Industries, Ltd.) were added as a polymerization initiator, and since white turbidity was observed in the reaction solution at this point, this was taken as the polymerization initiation point. The monomer concentration was calculated to be 15.0%. The external temperature (water bath temperature) was adjusted to maintain the internal temperature at 55° C. as the polymerization reaction was continued, and 6 hours after the start of polymerization the internal temperature was raised to 65° C. The internal temperature was maintained at 65° C., cooling of the reaction solution was initiated 12 hours after the start of the reaction, and once the internal temperature had fallen to 25° C., 52.5 parts of a lithium hydroxide monohydrate (hereunder, “LiOH.H₂O”) powder were added. After addition stirring was continued for 12 hours at room temperature to obtain a polymerization reaction solution in the form of a slurry comprising particles of a crosslinked polymer salt R-1 (Li salt, degree of neutralization 90 mol %) dispersed in a medium.

The resulting polymer reaction solution was centrifuged to precipitate the polymer particles, and the supernatant was removed. The precipitate was then re-dispersed in acetonitrile having the same weight as the polymerization reaction solution, and the washing operations of precipitating the polymer particles by centrifugation and removing the supernatant were repeated twice. The precipitate was collected and dried for 3 hours at 80° C. under reduced pressure to remove the volatile components and obtain a powder of the crosslinked polymer salt R-1. Because the crosslinked polymer salt R-1 is hygroscopic, it was sealed and stored in a container having water vapor barrier properties. When the powder of the crosslinked polymer salt R-1 was measured by IR and the degree of neutralization was determined from the intensity ratio of the peak derived from the C═O group of the carboxylic acid and the peak derived from the C═O of the lithium carboxylate, it was equal to the calculated value from charging, which was 90 mol %. The crosslinked polymer salt R-1 was stored sealed in a container having water vapor barrier properties.

The average particle diameter (water-swelled particle diameter) of the crosslinked polymer salt R-1 obtained above in an aqueous medium was measured and found to be 1.54 μm, and the particle size distribution was calculated to be 1.1. The water swelling degree at pH 8 was 91.9, while the water swelling degree at pH 4 was 21.5.

### Manufacturing Examples 2 to 21 and 23: Manufacturing Crosslinked Polymer Salts R-2 to R-21 and R-23

Polymerization reaction solutions containing crosslinked polymer salts R-2 to R-21 and R-23 were obtained by the same operations as in the manufacturing example 1 except that the input amounts of the raw materials were as shown in Tables 1 and 2.

Next, each polymerization reaction solution was subjected to the same operations as in the manufacturing example 1 to obtain crosslinked polymer salts R-2 to R-21 and R-23 in powder form. Each crosslinked polymer salt was stored sealed in a container having water vapor barrier properties.

Using the resulting polymer salts, the average particle diameters in aqueous medium and the water swelling degrees at pH 8 and pH 4 were measured as in the manufacturing example 1. The results are shown in Tables 1 and 2. Because R-20 is a non-crosslinked polymer, the particle size distribution and water swelling degree could not be measured.

In the manufacturing examples 16 to 18, LiOH.H₂O or NaOH was used as a neutralizing agent as shown in Tables 1 and 2 to obtain a crosslinked polymer Li salt with a degree of neutralization of 85 mol % or 70 mol % or a crosslinked polymer Na salt with a degree of neutralization of 90 mol %.

### Manufacturing Example 22: Manufacture of Crosslinked Polymer Salt R-22

A reactor equipped with a stirring blade, a thermometer, a reflux condenser and a nitrogen inlet pipe was used for polymerization.

300 parts of methanol, 100 parts of AA, 0.2 parts of allyl methacrylate (hereunder referred to as “AMA”, Mitsubishi Gas Chemical Company, Inc.) and 0.5 parts of Neoallyl™ P-30 were charged into a reactor. 32 parts of a LiOH.H₂O powder and 1.40 parts of ion-exchange water were then slowly added so that the internal temperature was maintained at 40° C. or less.

The inside of the reactor was thoroughly purged with nitrogen, and heated to raise the internal temperature to 68° C. Once the internal temperature was confirmed to have stabilized at 68° C., 0.02 parts of 4,4′-azobiscyanovaleric acid (product name “ACVA” by Otsuka Chemical Co., Ltd.) were added as a polymerization initiator, and since white turbidity was observed in the reaction solution at this point, this was taken as the polymerization initiation point. The polymerization reaction was continued with the external temperature (water bath temperature) being adjusted so as to gently reflux the solvent, and solvent reflux was maintained while 0.02 parts of ACVA were added 3 hours after the polymerization initiation point and an additional 0.035 parts of ACVA were added 6 hours after the polymerization initiation point. Cooling of the reaction solution was initiated 9 hours after the polymerization initiation point, the internal temperature was lowered to 30° C., and 20.5 parts of LiOH.H₂O powder were then added slowly so that the internal temperature did not exceed 50° C. After addition of the LiOH.H₂O powder, stirring was continued for 3 hours to obtain a slurry-like polymer reaction solution comprising particles of the crosslinked polymer salt R-22 (Li salt, degree of neutralization 90 mol %) dispersed in a medium.

The resulting polymer reaction solution was centrifuged to precipitate the polymer particles, and the supernatant was removed. The precipitate was then re-dispersed in acetonitrile having the same weight as the polymer reaction solution, and the operations of precipitating the polymer particles by centrifugation and removing the supernatant were repeated twice. The precipitate was collected and dried for 3 hours at 80° C. under reduced pressure to remove the volatile components and obtain a powder of the crosslinked polymer salt R-22. Because the crosslinked polymer salt R-22 is hygroscopic, it was sealed and stored in a container with water vapor barrier properties. When the powder of the crosslinked polymer salt R-22 was measured by IR and the degree of neutralization was determined from the intensity ratio of the peak derived from the C═O group of the carboxylic acid and the peak derived from the C═O of the lithium carboxylate, it was equal to the calculated value from charging, which was 90 mol %. The crosslinked polymer salt R-22 was stored sealed in a container having water vapor barrier properties.

Because crosslinked polymer salt R-22 obtained above swells greatly in water, measurement was impossible because the light diffraction/scattering necessary for particle size measurement could not be obtained. The water swelling degree at pH 8 was 203.3, and the water swelling degree at pH 4 was 73.8.

In addition to the crosslinked polymer salts R-1 to R-23 obtained in manufacturing examples 1 to 23 above, a commercial crosslinked polymer salt, crosslinked sodium polyacrylate (Toagosei Co., Ltd. product name “Rheogic 260H”) was also used as a crosslinked polymer salt. Because Rheogic 260H swells greatly in water, measurement was impossible because the light diffraction/scattering necessary for particle size measurement could not be obtained. The water swelling degree at pH 8 was 140.0, and the water swelling degree at pH 4 was 50.5. “Rheogic” is a registered trademark.

TABLE 1

| | | | Manufacturing Example No. | | | | | | | | | | | |
|---|---|---|---|---|---|---|---|---|---|---|---|---|---|---|
| | | | ME 1 | ME 2 | ME 3 | ME 4 | ME 5 | ME 6 | ME 7 | ME 8 | ME 9 | ME 10 | ME 11 | ME 12 |
| Crosslinked polymer (salt) | | | R-1 | R-2 | R-3 | R-4 | R-5 | R-6 | R-7 | R-8 | R-9 | R-10 | R-11 | R-12 |
| Input | Monomer | AA | 100 | 100 | 100 | 100 | 100 | 100 | 80 | 100 | 100 | 100 | 80 | 80 |
| (parts) | | MAA | | | | | | | 20 | | | | | |
| | | IBXA | | | | | | | | | | | 20 | |
| | | DMAA | | | | | | | | | | | | 20 |
| | Cross- | P-30 | 0.1 | 0.2 | 0.6 | 1.2 | 2.0 | 4.0 | 2.0 | 2.0 | 0.6 | 0.6 | 0.6 | 0.6 |
| | linkable | T-20 | | | | | | | | | | | | |
| | monomer | AMA | | | | | | | | | | | | |
| | Basic | LiOH•H₂O | | | | | | | | | | | | |
| | compound | TMA | | | | | | | | | 1.0 | 0.6 | | |
| | (mol %) | TOA | 1.0 | 1.0 | 1.0 | 1.0 | 1.0 | 1.0 | 1.0 | 1.0 | | | 1.0 | 1.0 |
| | Polymeri- | Ion | 2.20 | 2.20 | 2.20 | 2.20 | 2.20 | 2.20 | 2.20 | 8.58 | 2.20 | 2.20 | 2.20 | 2.20 |
| | zation | exchange | | | | | | | | | | | | |
| | solvent | water | | | | | | | | | | | | |
| | | AcN | 567 | 567 | 567 | 567 | 567 | 567 | 567 | 2470 | 567 | 567 | 567 | 567 |
| | | MeOH | | | | | | | | | | | | |
| | Polymeri- | V-65 | 0.040 | 0.040 | 0.040 | 0.040 | 0.040 | 0.040 | 0.040 | 0.125 | 0.040 | 0.040 | 0.040 | 0.040 |
| | zation | Initial | | | | | | | | | | | | |
| | initiator | ACVA | | | | | | | | | | | | |
| | | Added | | | | | | | | | | | | |
| | | ACVA | | | | | | | | | | | | |
| | Process | LiOH•H2O | 52.5 | 52.5 | 52.5 | 52.5 | 52.5 | 52.5 | 42.0 | 52.5 | 52.5 | 52.5 | 42.0 | 42.0 |
| | neutral- | NaOH | | | | | | | | | | | | |
| | ization | | | | | | | | | | | | | |

| Initial monomer concentration | | 15.0% | 15.0% | 15.0% | 15.0% | 15.0% | 15.0% | 15.0% | 4.0% | 15.0% | 15.0% | 15.0% | 15.0% |
|---|---|---|---|---|---|---|---|---|---|---|---|---|---|
| (wt %) | | | | | | | | | | | | | |
| Neutral- | Type | Li | Li | Li | Li | Li | Li | Li | Li | Li | Li | Li | Li |
| izing | Degree of neutralization | 90.0% | 90.0% | 90.0% | 90.0% | 90.0% | 90.0% | 90.0% | 90.0% | 90.0% | 90.0% | 90.0% | 90.0% |
| salt | | | | | | | | | | | | | |
| Water | Average particle size | 1.54 | 1.33 | 1.09 | 0.98 | 0.82 | 0.65 | 0.62 | 0.34 | 5.00 | 8.08 | 1.02 | 1.18 |
| swelled | [μm] pH 8 | | | | | | | | | | | | |
| state | Particle size distribution | 1.1 | 1.1 | 1.2 | 1.2 | 1.3 | 1.3 | 1.3 | 1.2 | 6.0 | 7.3 | 1.2 | 1.2 |
| | pH 8 | | | | | | | | | | | | |
| | Water swelling degree | 91.9 | 62.5 | 32.4 | 21.4 | 11.5 | 6.1 | 6.0 | 37.4 | 31.6 | 31.8 | 25.1 | 27.1 |
| | pH 8 | | | | | | | | | | | | |
| | Water swelling degree | 21.5 | 16.9 | 11.0 | 6.9 | 4.8 | 3.1 | 2.5 | 12.8 | 10.6 | 10.7 | 9.4 | 9.1 |
| | pH 4 | | | | | | | | | | | | |

TABLE 2

| | | | Manufacturing Example No. | | | | | | | | | | |
|---|---|---|---|---|---|---|---|---|---|---|---|---|---|
| | | | ME 13 | ME 14 | ME 15 | ME 16 | ME 17 | ME 18 | ME 19 | ME 20 | ME 21 | ME 22 | ME 23 |
| Crosslinked polymer (salt) | | | R-13 | R-14 | R-15 | R-16 | R-17 | R-18 | R-19 | R-20 | R-21 | R-22 | R-23 |
| Input | Monomer | AA | 60 | 20 | 100 | 100 | 100 | 100 | 100 | 100 | 100 | 100 | 100 |
| (parts) | | MAA | | | | | | | | | | | |
| | | IBXA | | | | | | | | | | | |
| | | DMAA | 40 | 80 | | | | | | | | | |
| | Crosslinkable | P-30 | 0.6 | 0.6 | | 0.6 | 0.6 | 0.6 | 0.6 | | 6.5 | 0.5 | 0.5 |
| | monomer | T-20 | | | 0.6 | | | | | | | | |
| | | AMA | | | | | | | | | | 0.2 | |
| | Basic | LiOH•H₂O | | | | | | | | | | 32.0 | |
| | compound | TMA | | | | | | | | | | | |
| | (mol/%) | TOA | 1.0 | 1.0 | 1.0 | 1.0 | 1.0 | 1.0 | 1.0 | 1.0 | 1.0 | | |
| | Polymerization | Ion exchange | 2.20 | 2.20 | 2.20 | 2.20 | 2.20 | 2.20 | 2.20 | 2.20 | 2.20 | 1.40 | 4.4 |
| | solvent | water | | | | | | | | | | | |
| | | AcN | 567 | 567 | 567 | 567 | 567 | 567 | 454 | 567 | 567 | | 876 |
| | | MeOH | | | | | | | 113 | | | 300 | |
| | Polymerization | V-65 | 0.040 | 0.040 | 0.040 | 0.040 | 0.040 | 0.040 | 0.040 | 0.040 | 0.040 | | 0.063 |
| | initiator | Initial ACVA | | | | | | | | | | 0.020 | |
| | | Added ACVA | | | | | | | | | | 0.055 | |
| | Process | LiOH•H2O | 31.5 | 10.5 | 52.5 | 49.6 | 40.9 | | 52.5 | 52.5 | 52.5 | 20.5 | 52.5 |
| | neutralization | NaOH | | | | | | 49.9 | | | | | |

| Initial monomer concentration (wt %) | | 15.0% | 15.0% | 15.0% | 15.0% | 15.0% | 15.0% | 15.0% | 15.0% | 15.0% | 23.0% | 10.0% |
|---|---|---|---|---|---|---|---|---|---|---|---|---|
| Neutral- | Type | Li | Li | Li | Li | Li | Na | Li | Li | Li | Li | Li |
| izing | Degree of neutralization | 90.0% | 90.0% | 90.0% | 85.0% | 70.0% | 90.0% | 90.0% | 90.0% | 90.0% | 90.0% | 90.0% |
| salt | | | | | | | | | | | | |
| Water | Average particle size [μm] | 1.18 | 1.20 | 1.40 | 110 | 1.05 | 1.11 | 10.8 | — | 0.65 | — | 1.73 |
| swelled | pH 8 | | | | | | | | | | | |
| state | Particle size distribution pH 8 | 1.3 | 1.4 | 1.1 | 1.1 | 1.2 | 1.2 | 1.4 | — | 1.4 | — | 1.2 |
| | Water swelling degree pH 8 | 25.0 | 20.9 | 56.9 | 32.2 | 29.8 | 32.3 | 62.1 | Dissolved | 4.5 | 203.3 | 116.5 |
| | Water swelling degree pH 4 | 8.8 | 8.0 | 16.5 | 10.9 | 10.0 | 12.0 | 23.7 | Dissolved | 2.3 | 73.8 | 33.6 |

The details of the compounds used in Tables 1 and 2 are as follows.

AA: Acrylic acid

MAA: Methacrylic acid

IBXA: Isobornyl methacrylate

DMAA: N,N-dimethylacrylamide

P-30: Pentaerythritol triallyl ether (Neoallyl P-30, manufactured by Daiso Co., Ltd.)

T-20: Trimethylol propane diallyl ether (Neoallyl T-20, manufactured by Daiso Co., Ltd.)

AMA: Allyl methacrylate

TMA: Trimethylamine (C/N value: 3)

TOA: Trioctylamine (C/N value: 24)

AcN: Acetonitrile

MeOH: Methanol

V-65: 2,2′-azobis(2,4-dimethylvaleronitrile) (Wako Pure Chemical Industries, Ltd.)

ACVA: 4,4′-azobiscyanovaleric acid (Otsuka Chemical Co. Ltd.)

(Evaluating Electrode)

Mixture layer compositions using the negative active material graphite or silicon particles and graphite as the active material and each crosslinked polymer salt as the binder were measured for coating properties and the peeling strength between the formed mixture layer and the collector (that is, the binding ability of the binder). Natural graphite (Nippon Graphite, product name “CGB-10”) was used as the graphite, and Si nanopowder (Sigma-Aldrich, particle diameter less than 100 nm) as the silicon particles.

### Example 1

3.2 parts of the crosslinked polymer Li salt R-1 in powder form were measured into 100 parts of natural graphite and thoroughly mixed in advance, after which 160 parts of ion exchange water were added and the mixture was pre-dispersed with a disperser. Main dispersion was then performed for 15 minutes with a thin film swivel mixer (Primix Corp., FM 56-30) at a peripheral speed of 20 m/second to obtain a negative electrode mixture layer composition in slurry form. The slurry concentration (solids) was calculated to be 39.2%.

This mixture layer composition was coated with a variable applicator onto a 20 μm-thick copper foil (Nippon Foil Mfg. Co., Ltd) and dried for 15 minutes at 100° C. in a ventilation drier to form a mixture layer. This was then pressed until the mixture layer had a thickness of 50±5 μm and a packing density of 1.70±0.20 g/cm³.

The external appearance of the resulting mixture layer was observed with the naked eye, and the coating properties were evaluated according to the following standard and judged as good (“A”).

(Coating Property Evaluation Standard)

A: No streaks, spots or other appearance defects observed on surface

B: Slight streaks, spots or other appearance defects observed on surface

C: Obvious streaks, spots or other appearance defects observed on surface

(90° Peel Strength (Binding Ability))

The negative electrode obtained above was cut into 25 mm-wide strips, and the mixture layer surface of the above sample was affixed to double-sided tape fixed on a horizontal surface to prepare a peeling test sample. The test sample was dried overnight under reduced pressure at 60° C. and then peeled at 90° at a tensile speed of 50 mm/minute, and the peeling strength between the mixture layer and the copper foil was measured. The peeling strength was as high as 16.2 N/m, which is good.

### Examples 2 to 21 and Comparative Examples 1 to 5

Mixture layer compositions were prepared by the same operations as in Example 1 except that the active materials and crosslinked polymer salts used as binders were as shown in Tables 3 to 5. In Examples 4 and 5, natural graphite and silicon particles were stirred for 1 hour at 400 rpm with a planetary ball mill (Fritsch, P-5), and 3.2 parts of the crosslinked polymer Li salt R-3 in powder form were weighed into the resulting mixture and mixed in advance, after which the same operations were performed as in Example 1 to prepare a mixture layer composition. The coating properties and 90° peeling strength of each mixture layer composition were evaluated, with the results shown in Tables 3 to 5.

TABLE 3

| | | Example | Example | Example | Example | Example | Example | Example | Example | Example | Example |
|---|---|---|---|---|---|---|---|---|---|---|---|
| | | 1 | 2 | 3 | 4 | 5 | 6 | 7 | 8 | 9 | 10 |
| Active | Graphite | 100 | 100 | 100 | 90 | 80 | 100 | 100 | 100 | 100 | 100 |
| material | Silicon | | | | 10 | 20 | | | | | |
| | particles | | | | | | | | | | |
| Crosslinked | Type | R-1 | R-2 | R-3 | R-3 | R-3 | R-4 | R-5 | R-6 | R-7 | R-8 |
| polymer | Parts | 3.2 | 3.2 | 3.2 | 3.2 | 3.2 | 3.2 | 3.2 | 3.2 | 3.2 | 3.2 |

| | | | | | | | | | | |
|---|---|---|---|---|---|---|---|---|---|---|
| Ion exchange water | 160 | 160 | 160 | 160 | 160 | 160 | 160 | 160 | 160 | 160 |
| Mixture layer slurry | 39.2% | 39.2% | 39.2% | 39.2% | 39.2% | 39.2% | 39.2% | 39.2% | 39.2% | 39.2% |
| concentration | | | | | | | | | | |
| Coating properties | A | A | A | A | A | A | A | A | A | A |
| Peeling strength N/m | 16.2 | 15.7 | 15.2 | 13.6 | 12.5 | 14.0 | 12.3 | 12.9 | 11.0 | 13.7 |

TABLE 4

| | | Example | Example | Example | Example | Example | Example | Example | Example | Example | Example | Example |
|---|---|---|---|---|---|---|---|---|---|---|---|---|
| | | 11 | 12 | 13 | 14 | 15 | 16 | 17 | 18 | 19 | 20 | 21 |
| Active | Graphite | 100 | 100 | 100 | 100 | 100 | 100 | 100 | 100 | 100 | 100 | 100 |
| material | Silicon | | | | | | | | | | | |
| | particles | | | | | | | | | | | |
| Cross- | Type | R-9 | R-10 | R-11 | R-12 | R-13 | R-14 | R-15 | R-16 | R-17 | R-18 | R-19 |
| linked | Parts | 3.2 | 3.2 | 3.2 | 3.2 | 3.2 | 3.2 | 3.2 | 3.2 | 3.2 | 3.2 | 3.2 |
| polymer | | | | | | | | | | | | |

| | | | | | | | | | | | |
|---|---|---|---|---|---|---|---|---|---|---|---|
| Ion exchange | 160 | 160 | 160 | 160 | 160 | 160 | 160 | 160 | 160 | 160 | 160 |
| water | | | | | | | | | | | |
| Mixture layer | 39.2% | 39.2% | 39.2% | 39.2% | 39.2% | 39.2% | 39.2% | 39.2% | 39.2% | 39.2% | 39.2% |
| slurry | | | | | | | | | | | |
| concentration | | | | | | | | | | | |
| Coating properties | B | B | A | A | A | A | A | A | A | A | B |
| Peeling strength | 12.0 | 11.8 | 18.0 | 16.0 | 14.7 | 12.0 | 15.6 | 15.3 | 14.8 | 14.8 | 12.0 |
| N/m | | | | | | | | | | | |

TABLE 5

| | | CE 1 | CE 2 | CE 3 | CE 4 | CE 5 |
|---|---|---|---|---|---|---|
| Active | Graphite | 100 | 100 | 100 | 100 | 100 |
| material | Silicon | | | | | |
| | particles | | | | | |
| Crosslinked | Type | R-20 | R-21 | R-22 | R-23 | Rheogic |
| polymer | | | | | | 260H |
| | Parts | 3.2 | 3.2 | 3.2 | 3.2 | 3.2 |

| | | | | | |
|---|---|---|---|---|---|
| Ion exchange water | 160 | 160 | 160 | 160 | 160 |
| Mixture layer slurry | 39.2% | 39.2% | 39.2% | 39.2% | 39.2% |
| concentration | | | | | |
| Coating properties | A | A | C | A | C |
| Peeling strength N/m | 6.5 | 9.5 | 8.4 | 6.9 | 8.2 |

The Examples involve electrode mixture layer compositions containing binders for secondary battery electrodes of the present teaching and electrodes prepared using the same. The coating properties of each mixture layer composition (slurry) were good, and the peel strength between the mixture layer and the collector of the resulting electrode was high in all cases, indicating excellent binding ability.

In terms of the coating properties, in comparison with the Examples 11 and 12 using the crosslinked polymer salts R-9 and R-10 having relatively broad particle size distributions and the Example 21 using the crosslinked polymer salt R-19 having a large water-swelled particle diameter, smoother mixture layers were obtained in the other examples.

The results of Examples 1 to 3 and Examples 6 to 8 also show that given the same composition and particle diameter, better peeling strength (binding ability) is obtained when using a crosslinked polymer salt having a high water swelling degree.

On the other hand, adequate binding ability was not obtained with the non-crosslinked polymer salt R-20 and the crosslinked polymer salt R-21 having an excessive degree of crosslinking and a low water swelling degree (Comparative Examples 1 and 2). Binding ability was also inadequate in Comparative Example 4 even though this example uses a crosslinked polymer salt with a high water swelling degree. In Comparative Examples 3 and 5, which uses crosslinked polymer salts with even higher water swelling degree, the highly viscous state of the mixture layer composition could be observed with the naked eye, and the coating properties were inferior.

### Examples 22 to 23, Comparative Example 6

### (Evaluating Battery Characteristics)

Batteries were prepared using the crosslinked polymer salts R-3 and R-5 and Rheogic 260H (all of which are crosslinked polyacrylate salts) as binders, and the resistance values were measured. The specific operating procedures were as follows.

### (Preparing Negative Electrode Plate)

SiO surface coated with carbon by the CVD method was prepared, and a mixture of this with graphite at a volume ratio of 5:95 was used as the active material. A mixture of a crosslinked polyacrylate salt, styrene/butadiene latex (SBR) and carboxymethyl cellulose (CMC) was used as the binder. Using water as the dilution solvent, these were mixed at a weight ratio of active material:crosslinked polyacrylate salt:SBR:CMC=95.5:1.5:1.5:1.5 (as solids) with a Primix T.K. Filmics 80-50, to prepare a negative electrode mixture slurry comprising 47% solids. This negative electrode mixture slurry was coated on both sides of a copper foil, and dried to form a mixture layer. This was then pressed so that the thickness of the mixture layer was 80 μm on each side, and the packing density was 1.6 g/cm³. The crosslinked polymer salts R-3 and R-5 obtained in the above manufacturing examples and Rheogic 260H were used for the crosslinked polyacrylic acid.

(Preparing Positive Electrode Plate)

Nickel-cobalt-aluminum oxide (LNCA) as a positive electrode active material was mixed with polyvinylidene fluoride (PVDF) and a conductive aid (carbon black and graphite) at a weight ratio of 92:4:4 with a mixer in an NMP solvent, to prepare a positive electrode mixture slurry. The prepared slurry was coated on both sides of an aluminum foil, dried, and pressed so that the thickness of the mixture layer was 88 μm on each side and the packing density was 3.1 g/cm³.

(Preparing Electrolyte Solution)

2 wt % of vinylene carbonate (VC) was added to a mixed solvent of ethylene carbonate (EC) and ethyl methyl carbonate (DEC) (volume ratio EC:DEC=25:75 (v/v)), and a 1 mol/liter solution of LiPF6 was added to prepare a non-aqueous electrolyte.

(Preparing Battery)

The battery was configured by alternately laminating positive and negative electrodes and separators (polyolefin, thickness 15 μm), ultrasonically welding the tab leads, and packaging this by heat sealing an external aluminum laminate material to prepare a laminated element. For the layers, 7 positive electrode and 8 positive electrode layers were used (14 separators per cell). The laminated element was vacuum dried for 8 hours at 80° C., injected with liquid, and sealed to obtain a test battery. This prototype battery had a design capacity of 1,100 mAh. The design capacity of the battery was designed based on the end-of-charge voltage up to 4.2 V.

(Measuring DC Resistance (Initial Resistance))

The DC resistance of a battery prepared as described above was measured. Specifically, each sample was adjusted to a state of SOC 50% and discharged for 10 seconds at a constant current value of 1 C in a 25° C. environment, and the battery voltage value was measured upon completion of discharge. Discharge was also performed under the same conditions except that only the discharge current was changed to 3 C and 5 C, and the battery voltage value upon completion of 10 seconds of discharge was then measured at each discharge current value. For each sample, the data obtained from the above discharge were then plotted on a coordinate plane with the discharge current value on the horizontal axis and the battery voltage upon completion of discharge on the vertical axis. An approximate straight line (linear expression) was then calculated by the least squares method based on these plotted data for each sample. The slope was obtained as the DC resistance value for each sample, with the results shown in Table 6.

TABLE 6

| | | Example | Example | CE |
|---|---|---|---|---|
| | | 22 | 23 | 6 |
| Active material | | 95.5 | 95.5 | 95.5 |
| (Graphite/SiO = 95/5) | | | | |
| Crosslinked | R-3 | 1.5 | | |
| polymer | R-5 | | 1.5 | |
| | Rheogic 260H | | | 1.5 |

| | | | |
|---|---|---|---|
| SBR | 1.5 | 1.5 | 1.5 |
| CMC | 1.5 | 1.5 | 1.5 |
| Initial resistance mΩ | 109 | 107 | 125 |

In Examples 22 and 23, the initial resistance values of 109 mΩ and 107 mΩ for the respective batteries are lower than the corresponding value of 125 mΩ for the Rheogic 260H, which has a large water swelling value. This shows that a battery with a low initial resistance value can be obtained when using a binder for a secondary battery electrode according to the present teaching.

### INDUSTRIAL APPLICABILITY

Because the binder for a secondary battery electrode of the present teaching exhibits excellent binding ability in a mixture layer, a secondary battery provided with an electrode obtained using this binder is expected to have good durability (cycle characteristics), and should be applicable to vehicle-mounted secondary batteries. This is also useful when using an active material containing silicon and is expected to contribute to higher battery capacity.

The binder for a secondary battery electrode of the present teaching can be used favorably in non-aqueous electrolyte secondary battery electrodes in particular and is especially useful for non-aqueous electrolyte lithium ion secondary batteries with high energy density.

### REFERENCE SIGNS LIST

1 Burette
2 Pinch cock
3 Silicone tube
4 Polytetrafluoroethylene tube
5 Funnel
6 Sample (crosslinked polymer or salt thereof)
7 Filter paper for fixing sample (crosslinked polymer or salt thereof)
8 Support cylinder
9 Adhesive tape
10 Filter paper for apparatus
11 Lid
12 Ion exchange water or phthalate pH standard solution

1. A binder for a secondary battery electrode, the binder containing a crosslinked polymer or salt thereof,
wherein the crosslinked polymer or salt thereof is configured to have a water swelling degree at pH 8 of 5.0 or more and 10.0 or less.

2. The binder for a secondary battery electrode according to claim 1, wherein the crosslinked polymer or salt thereof is configured to have a water swelling degree at pH 4 of at least 2.0.

3. The binder for a secondary battery electrode according to claim 1, wherein the crosslinked polymer has a structural unit derived from an ethylenically unsaturated carboxylic acid monomer in an amount of 50 mass % or more and 100 mass % or less of the total structural units of the crosslinked polymer.

4. The binder for a secondary battery electrode according to claim 1, wherein the crosslinked polymer has been crosslinked with a crosslinkable monomer.

5. The binder for a secondary battery electrode according to claim 1, wherein the crosslinked polymer, after being neutralized to a degree of neutralization of 80% or more and 100 mol % or less, has a particle diameter measured in an aqueous medium of 0.1 μm or more and 10 μm or less as a volume-based median diameter.

6. The binder for a secondary battery electrode according to claim 1, wherein the crosslinked polymer, after being neutralized to a degree of neutralization of 80 mol % or more and 100 mol % or less, has a particle size distribution of 1.5 or less, the particle size distribution obtained by dividing the volume average particle size measured in an aqueous medium by the number average particle size.

7. A secondary battery electrode mixture layer composition, comprising: the binder according to claim 1; an active material; and water.

8. The secondary battery electrode mixture layer composition according to claim 7, comprising a carbon material or a silicon material as a negative electrode active material.

9. A secondary battery electrode comprising, a mixture layer formed from the secondary battery electrode mixture layer composition according to claim 7 on a surface of a collector.

10. A secondary battery electrode comprising, a mixture layer formed from the secondary battery electrode mixture layer composition according to claim 8 on a surface of a collector.

11. The binder for a secondary battery electrode according to claim 1,
wherein the crosslinked polymer or salt thereof has a water swelling degree at pH 4 of at least 2.0; and
wherein the crosslinked polymer, after being neutralized to a degree of neutralization of 80% or more and 100 mol % or less, has a particle diameter measured in an aqueous medium of 0.1 μm or more and 10 μm or less as a volume-based median diameter.

12. The binder for a secondary battery electrode according to claim 10,
wherein the crosslinked polymer, after being neutralized to a degree of neutralization of 80 mol % or more and 100 mol % or less, has a particle size distribution of 1.5 or less, the particle size distribution obtained by dividing the volume average particle size measured in an aqueous medium by the number average particle size.

13. A method, comprising, preparing a secondary battery electrode mixture layer composition using a binder according to claim 1.

14. A secondary battery electrode comprising, a mixture layer containing a binder according to claim 1 on a surface of a collector.

15. A method comprising:
preparing a mixture layer using the secondary battery electrode mixture layer composition according to claim 7 on a surface of a collector, and
manufacturing a secondary battery electrode comprising the mixture layer.

16. A method comprising:
preparing a mixture layer using the secondary battery electrode mixture layer composition according to claim 8 on a surface of a collector, and
manufacturing a secondary battery electrode comprising the mixture layer.
